(19) United States
(12) Patent Application Publication
(10) Pub. No.: US 2025/0010210 A1
(43) Pub. Date: Jan. 9, 2025

(54) FRICTIONLESS AI-ASSISTED VIDEO GAME MESSAGING SYSTEM

(71) Applicant: Sony Interactive Entertainment Inc., Tokyo (JP)

(72) Inventors: Ruxue Peng, San Mateo, CA (US); Aria Lin, Sunnyvale, CA (US); Toshimasa Aoki, Kawasaki (JP); Ai Sasho, San Mateo, CA (US); Yuanhan Chen, San Mateo, CA (US); Jihun Choi, San Mateo, CA (US); Fernando Ruiz Echeverria, San Francisco, CA (US); Trang Ho, San Mateo, CA (US); Robert Brown, Lafayette, CA (US); Ryder McMinn, San Francisco, CA (US)

(21) Appl. No.: 18/219,593

(22) Filed: Jul. 7, 2023

(51) Int. Cl. A63F 13/87; A63F 13/525; A63F 13/86; H04L 51/046

(52) U.S. Cl. CPC A63F 13/87; A63F 13/525; A63F 13/86; H04L 51/046

(57) ABSTRACT

In a video game message generation system, a first neural network may analyze a player's gameplay data in real time to determine a moment of gameplay to record. A recording module records the moment of gameplay determined with the first trained neural network. A second trained neural network determines one or more recipients for the recording of the determined moment and a third trained neural network operable drafts a message associated with the determined moment to the determined recipient(s). A user interface presents the player an opportunity send the recording of the determined moment and the one or more messages to the one or more recipients.

### FIELD OF THE DISCLOSURE

Aspects of the present disclosure are related to video games and more specifically to automated generation of messages for video games.

### BACKGROUND OF THE DISCLOSURE

Game players often want to share highlights of their gameplay achievements with friends electronically, e.g., via gaming platform networks or social media applications. This is most rewarding when it can be done “in the moment” of an achievement or as close to the moment of achievement as possible. Unfortunately, this can be an awkward and time-consuming process. For example, when a player wants to share video of the moment of the achievement, they must select the relevant portion of gameplay video to record, select the recipient of the video, prepare a message using a game controller, and click submit. Taking these actions can detract from the spontaneity of the moment.

It is within this context that aspects of the present disclosure arise.

### BRIEF DESCRIPTION OF THE DRAWINGS

The teachings of the present disclosure can be readily understood by considering the following detailed description in conjunction with the accompanying drawings, in which:

FIG. 1 is a schematic diagram of an automated video game messaging system according to an aspect of the present disclosure.

FIG. 2 is a flow diagram of a method for automated video game messaging according to an aspect of the present disclosure.

FIG. 3 is a diagram showing an example of a multi-modal data collection architecture for an automated video game messaging system according to an aspect of the present disclosure.

FIG. 4 depicts an example of a game screen of a video game that implements automated messaging for video games according to an aspect of the present disclosure.

FIG. 5 is a schematic diagram depicting an example layout of modal modules in a multi-modal recognition network of an inference engine that may be used in conjunction with an automated video game messaging according to aspects of the present disclosure.

FIG. 6 is a flow diagram of a method for training a neural-network to implement a method for automated video game messaging according to an aspect of the present disclosure.

FIG. 7A is a simplified node diagram of a recurrent neural network that may be used in automated video game messaging according to aspects of the present disclosure.

FIG. 7B is a simplified node diagram of an unfolded recurrent neural network that may be used in automated video game messaging according to aspects of the present disclosure.

FIG. 7C is a simplified diagram of a convolutional neural network that may be used in automated video game messaging according to aspects of the present disclosure.

FIG. 7D is a block diagram of a method for training a neural network that may be used in automated video game messaging according to aspects of the present disclosure.

FIG. 8 is a block diagram of a system implementing an automated messaging system for video games according to an aspect of the present disclosure.

FIG. 9 is a block diagram of a computer-readable medium encoded with instructions that, upon execution implement a method for automated messaging in video games according to an aspect of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the disclosure. Accordingly, examples of implementations according to aspects of the present disclosure described below are set forth without any loss of generality to, and without imposing limitations upon, the claims that follow the description.

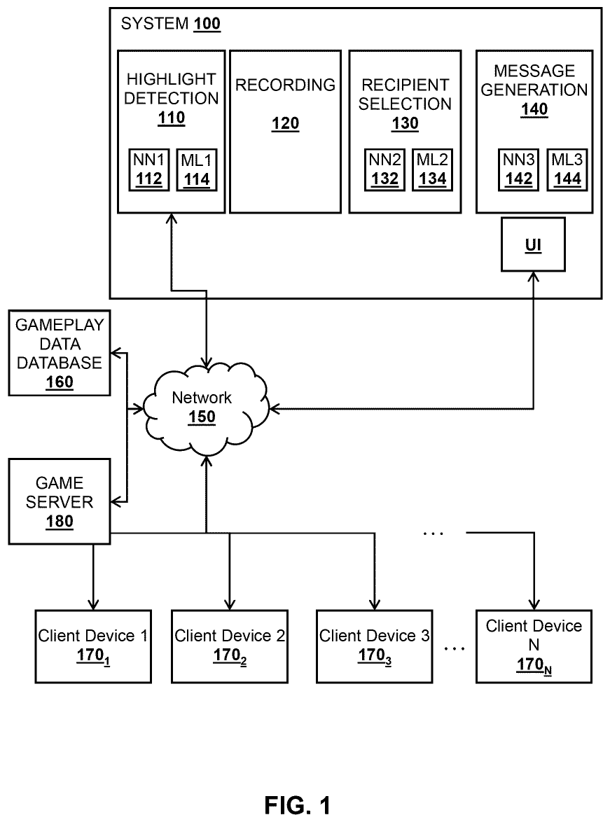

The block diagram shown in FIG. 1 depicts a non-limiting example of an implementation of an automated video game messaging system 100, according to some aspects of the present disclosure. In implementation depicted, the system 100 includes a highlight detection module 110 operable to collect and analyze gameplay data for a video game in real time to select a moment of gameplay to record, a recording module 120 operable to record the selected moment of gameplay, a recipient selection module 130 operable to determine one or more recipients for the recording of the determined moment, a message generation module 140 operable to draft one or more messages associated with the determined moment to the one or more determined recipients, and a user interface UI operable to present the player an opportunity send the recording of the determined moment and the one or more messages to the one or more recipients.

Components of the system 100 may be operable to communicate with other devices over a Network 150, e.g., through a suitably operable network interface. For example, the highlight selection module 110 may retrieve gameplay data over the network 150 from a remote gameplay data database 160. The gameplay data database 160 may, in turn, collect gameplay date from an arbitrary number N of client devices 170₁, 170₂, 170₃ . . . 170_{N}, which may be gaming consoles, portable gaming devices, desktop computers, laptop computers or mobile devices, such as tablet computers or cell phones that are operable to allow players to play the game. The gameplay database 160 may additionally receive gameplay data from a game server 180 that is operable to perform computations and other functions that allow the players to play the game via the client devices 170₁, 170₂, 170₃ . . . 170_{N}.

In some implementations, the highlight detection module 110 may include a first neural network 112 that is trained to detect patterns in gameplay data that may be associated with gameplay moments that the player would like to share. The first neural network 112 may be trained with a suitably operable machine learning algorithm 114. The recording module 120 may then record the gameplay moment, e.g., by recording video of the relevant gameplay and storing it either locally, e.g., on the players client device or remotely, e.g., at a remote storage server.

One or more of the neural networks 112 may be trained to optimize the determined moment of gameplay for sharing with the one or more recipients. By way of non-limiting example, one or more of the neural networks 112 may be trained to optimize the determined moment of gameplay for maximum view counts for publicly shared gameplay video. In some implementations, one or more of the neural networks 112 may be trained to choose a virtual camera angle from which to record the determined moment of gameplay. In some implementations, the latter functionality may be incorporated into the recording module 120.

In some implementations, the recipient selection module 130 may include a second neural network 132 that is trained to analyze the recorded moment to identify recipients for the message recorded by the recording module. The second neural network 132 may be trained with a suitably operable machine learning algorithm 134. One or more of the neural networks 132 may be trained to determine the one or more recipients from among a plurality of other players associated with the player. By way of non-limiting example, the second neural network 132 may be trained to identify suitable recipients, e.g., by decomposing recorded game video and audio into various elements and determine a degree of affinity of one or more potential recipients for each of the various elements. An aggregated affinity score may be determined for each potential recipient and a reduced list may be generated, e.g., by listing those with affinity scores above some threshold.

The recipient selection module may analyze other sources of information, including the gameplay data and the player's profile data. By way of example, and not by way of limitation, the recipient selection module 130 may access information from the player's online social media applications to identify the player's friends and determine which games they own. The recipient selection module may also have access to gameplay data that identifies the game from which the highlight moment has been recorded. Friends that play the same game may be selected as potential recipients. In some implementations, the recipient selection module may consider people who play games together that are more likely to be receptive to highlights from each other. For example, the recipient selection module may analyze information related to user generated content (UGC) created by the player, such as whether any UGC relates to a game, which game, who viewed it, who commented on it, who is compatible with the user.

Some players who share gameplay videos may tag their shared videos with information related to why they are sharing it. The recipient selection module 130 may compare similarities in videos the player shares to videos that other players share and prioritize recipients with a relatively high degree of similarity. Recipients may include others that do not play the game. Some players want to share highlights to encourage others who are not playing to play the game.

In some implementations, the message drafting module 140 may include one or more trained networks 142 trained with one or more suitably operable machine learning algorithms 144. By way of example, these may include a neural network trained to draft one or more messages associated with the recorded determined moment to the one or more determined recipients. In some implementations, one or more of the neural networks 142 may be trained to draft the message with a tone based on the one or more recipients, the recording of the determined moment that corresponds to the highlight, analysis of messages sent by the player, a title of the video game, the player's gameplay data or some combination of two or more of these. Furthermore, one or more of the neural networks 142 may be trained to draft the message from one or more inputs provided by the player, such as words, icons, or emojis or to suggest one or more such inputs.

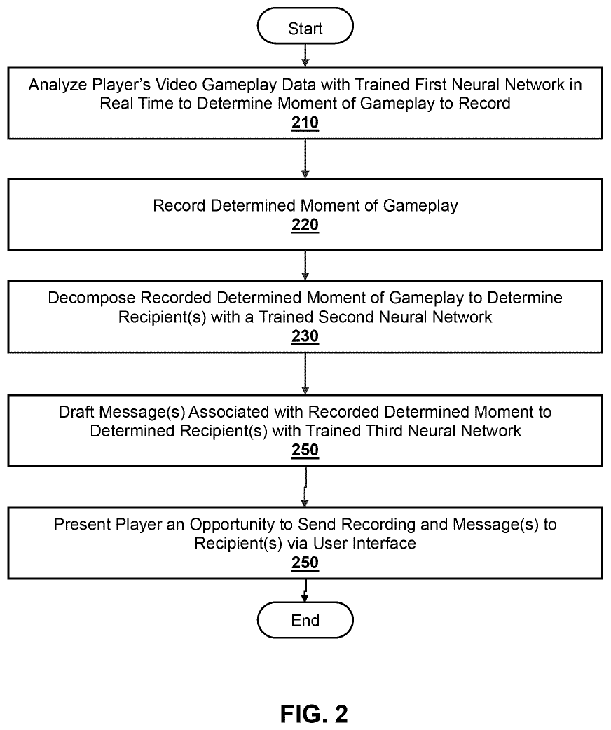

FIG. 2 is a flow diagram that describes an automated message generation method for a video game, according to some aspects of the present disclosure. In some implementations, the method may include analyzing a player's gameplay data for a video game with a first neural network in real time to determine a moment of gameplay to record as indicated at 210. As used herein analyzing data “in real time” refers to analyzing data as soon as it appears in a system. There are a number of types of gameplay data that may be collected and analyzed by the highlight detection module 110. Collecting the data depends partly on the source of the data. Some data, such as controller inputs, may be collected directly from a player's gaming console or portable gaming device. In online gaming implementations, some data may be collected from the game server 180 that implements certain computations based on a player's controller inputs and transmits video data back to the player's device. Still other data may be collected from a data service associated with the game server. Other data may be collected from social media services that are associated with the game server or with the player. The highlight detection module 110 may analyze gameplay data collected over some predetermined window of time. The window of time may be long enough to collect enough data to be useful highlight detection module 110. The highlight detection module may determine a start and end time for the moment of play to record and transmit this information to the recording module.

There are a number of different types of data that may be analyzed. Some non-limiting examples include current game level, current game activity, player character load out (e.g., weapons or equipment), player rank, time spent on a game session, time spent in a particular region or level of a game world, and number of times a player has failed at a particular task, just to name a few. In some implementations, structured gameplay data that may be relevant to choosing a moment of gameplay to record, determining one or more recipients and drafting a message a game engine running on one or more of the client devices 170₁, 170₂, 170₃ . . . 170_{N} or on the game server 180. Such structured data may include, e.g., the game title, current game level, current game task, time spent on current task or current level, number of previous attempts at current task by the player, current game world locations for player and non-player characters, game objects in a player character's inventory, player ranking, and the like.

In some implementations, the highlight detection module 110 may collect video game telemetry data. Game telemetry data can provide insight in to what activity player is doing, what equipment or weapons a player character can access, the player's game world location, the amount of time within a game world region, or how many times players failed an activity, among other things. As used herein, video game telemetry data refers to the information collected by games through various sensors, trackers, and other tools to monitor player behavior, game performance, and other relevant metrics. Some examples of video game telemetry data include (1) player activity, such as data on how long players spend on specific levels or missions, the frequency of their logins, the amount of time spent in the game, and how often they return to the game, (2) in-game actions performed by players, such as the number of kills or deaths in a first-person shooter game, or the number of goals scored in a soccer game, (3) game performance including data on how the game performs, such as the frame rate, latency, and other technical metrics that can impact the player experience, (4) player engagement, such as the number of times they use specific features or interact with certain game elements, (5) error reports generated by the game or experienced by players. (6) platform information, such as device type, and operating system, (7) user demographic information, such as age, gender, location, and other relevant data, (8) social features, such as how player interact each other with in-game chat and friend invites, (9) in-game economy, such as tracking patterns of purchases and/or sales of virtual items, and (10) progression, such as tracking player achievements and/or trophies and/or pace of progress. Additional examples of telemetry data include game title, game type, highest resolution provided, and highest frame rate (e.g., in frames per second) provided.

In some implementations, the gameplay data may be visualized in the form heat maps of relevant information with respect to time or location within a game world. Such relevant information may include, but is not limited to, controller inputs, trophies, movement of player characters, interactions between players in multi-player games, interactions between player and non-player characters in single player games, and combinations of two or more of these.

There are a number of ways in which the neural networks 112 may analyze the data to look for patterns consistent with a moment worth recording. For example, in many games some bosses are hard to defeat and some weapons or tools are harder to use. Certain objects might be rarely seen in the game or certain locations might be rarely visited in the game world. The neural network 112 may be trained to take into account information regarding, e.g., bosses, weapons, tools, object rarity, location rarity, task difficulty, past successes, past failures, etc., when determining the moment of gameplay to record.

In some implementations, the gameplay data include data regarding user generated content (UGC) that the player has uploaded for sharing. Such data may include a view count, peak watch time. The gameplay data may also include the player's facial expression, e.g., as determined from image analysis of video from a digital camera trained on the player and/or UGC.

The first neural network 112 could use a training data set selected for optimizing recorded gameplay video to maximize view counts for publicly shared videos instead of a training data set selected to optimize the recorded gameplay video for sharing with friends.

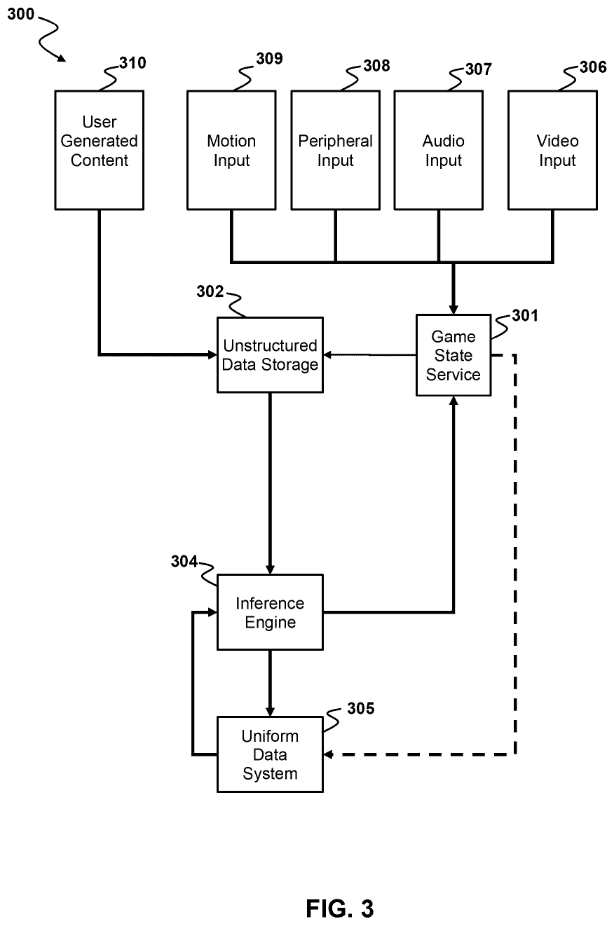

In some implementations, the highlight detection module 110 in the system 100 may collect and analyze unstructured gameplay data, such as video image data, game audio data, controller input data, group chat data, and the like. It may be useful to provide structure to such data to facilitate processing by the recipient selection module 130, and message drafting module 140. Furthermore, the highlight detection module 110 may collect and analyze different modes of data, such as video data, audio data, along with structured data. FIG. 3 is a diagram showing an example of data collection system architecture 300 for an automated message system that can collect multi-modal gameplay data. In the implementation shown the system 300 may execute an application that does not expose the application data structure to a uniform data system 305, which may include the gameplay database 160. Instead, the inputs to the application such as peripheral input 308 and motion input 309 are interrogated by a game state service 301 and sent to unstructured data storage 302. The game state service 301 also interrogates unstructured application outputs such as video data 306 and audio data 307 and stores the data with unstructured data storage 302. Additionally, user generated content (UGC) 310 may be used as inputs and provided to the unstructured data storage 302. The game state service 301 may collect raw video data from the application which has not entered the rendering pipeline of the device. Additionally, the game state service 301 may also have access to stages of the rendering pipeline and as such may be able to pull game buffer or frame buffer data from different rendered layers which may allow for additional data filtering. Similarly raw audio data may be intercepted before it is converted to an analog signal for an output device or filtered by the device audio system.

The inference engine 304 receives unstructured data from the unstructured data storage 302 and predicts context information from the unstructured data. The context information predicted by the inference engine 304 may be formatted in the data model of the uniform data system. The inference engine 304 may also provide context data for the game state service 301 which may use the context data to pre-categorize data from the inputs based on the predicted context data. In some implementations, the game state service 301 may provide game context updates at update points or at game context update interval to the data system 305. These game context updates may be provided by the data system 305 to the inference engine 304 and used as base data points that are updated by context data generated by the inference engine. The context information may then be provided to the uniform data system 305. The UDS 305 may also provide structured information to the inference engine 304 to aid in the generation of context data.

In some implementations, it may be desirable to reduce the dimensionality of the gameplay data collected and/or analyzed by the highlight detection module 110. Data dimensionality may be reduced through the use of feature vectors. As used herein, a feature vector refers to a mathematical representation of a set of features or attributes that describe a data point. It can be used to reduce the dimensionality of data by converting a set of complex, high-dimensional data into a smaller, more manageable set of features that capture the most important information.

To create a feature vector, a set of features or attributes that describe a data point are selected and quantified. These features may include numerical values, categorical labels, or binary indicators. Once the features have been quantified, they may be combined into a vector or matrix, where each row represents a single data point and each column represents a specific feature.

The dimensionality of the feature vector can be reduced by selecting a subset of the most relevant features and discarding the rest. This can be done using a variety of techniques, including principal component analysis (PCA), linear discriminant analysis (LDA), or feature selection algorithms. PCA, for example, is a technique that identifies the most important features in a dataset and projects the data onto a lower-dimensional space. This is done by finding the directions in which the data varies the most, and then projecting the data onto those directions. The resulting feature vector has fewer dimensions than the original data, but still captures the most important information. As an example, consider a dataset corresponding to images of different objects, where each image is represented by a matrix of pixel values. Each pixel value in the matrix represents the intensity of the color at that location in the image. Treating each pixel value as a separate feature results in a very high-dimensional dataset, which can make it difficult for machine learning algorithms to classify or cluster the images. To reduce the dimensionality of the data, the system 100, e.g., highlight detection module 110 and/or recipient selection module 130 and/or message drafting module 140 may create feature vectors that summarize the most important information in each image, e.g., by calculating the average intensity of the pixels in the image, or extracting features that capture the edges or shapes of the objects in the image. Once a feature vector is created for each image, these vectors can be used to represent the images in a lower-dimensional space, e.g., by using principal component analysis (PCA) or another dimensionality reduction technique to project the feature vectors onto a smaller number of dimensions.

Referring again to FIG. 2, at 220, the recording module 120 may record moment of gameplay determined by the highlight detection module 110. The recording module may buffer game output data, e.g., audio, video and haptic data over a rolling window of time and record the data buffered between starts and end times determined by the highlight detection module. Recording the data may involve saving it to memory or a storage device, such as a hard drive. The recorded data may be compressed to facilitate transmission over the network 150. In some implementations the recorded data may be stored in a digital audio/video (A/V) format suitable for playback on a video playback device or computer. Examples of such formats include MP3, MPEG and H-265. In other implementations the recorded data may be stored in a format suitable for playback on a video game console. Such a format may allow playback of audio, video, and haptics to provide a more immersive experience to the recipient. In other implementations, the recorded data may include save state information for the game so that a particular scenario in the game corresponding to the highlight can be replayed, e.g., using a game engine.

The recipient selection module 130 may decompose the recorded determined moment of gameplay to determine one or more recipients for the recording of the determined moment, e.g., using one or more of the trained neural networks 132. Decomposing the recorded moment may involve analyzing contextual elements of the recording such as, the game title, the game level, the game task, game world location, objects, and characters depicted in the recording. Decomposing the recorded moment may include analyzing audio elements of the recording, such as sounds, music, and player audio chat. The recipient selection module may compare these features against profiles of other potential recipients. Such potential recipients may include other players who play the game or other persons that the player would like to encourage to play the game. Each of these players may have an affinity for certain elements of the recording. Such affinities may be stored as part of a player profile, which may be stored in a database, such as the gameplay database 160. The recipient selection module 130 may compare the elements in the recording to these affinities to narrow down the possible recipients of the recording.

The message generation module 140 may perform a sentiment analysis of the player's text or chat messages to estimate a tone for the message and use that as an input to the third trained neural network 142. In some implementations, the style of language of the message might be different for different game titles. Thus, the game title itself may be another channel of input for determining tone of the message. In addition, the message module 140 may analyze gameplay data to determine tone of message. The message module 140 may analyze the same gameplay data used by the highlight detection module 110 or different gameplay data.

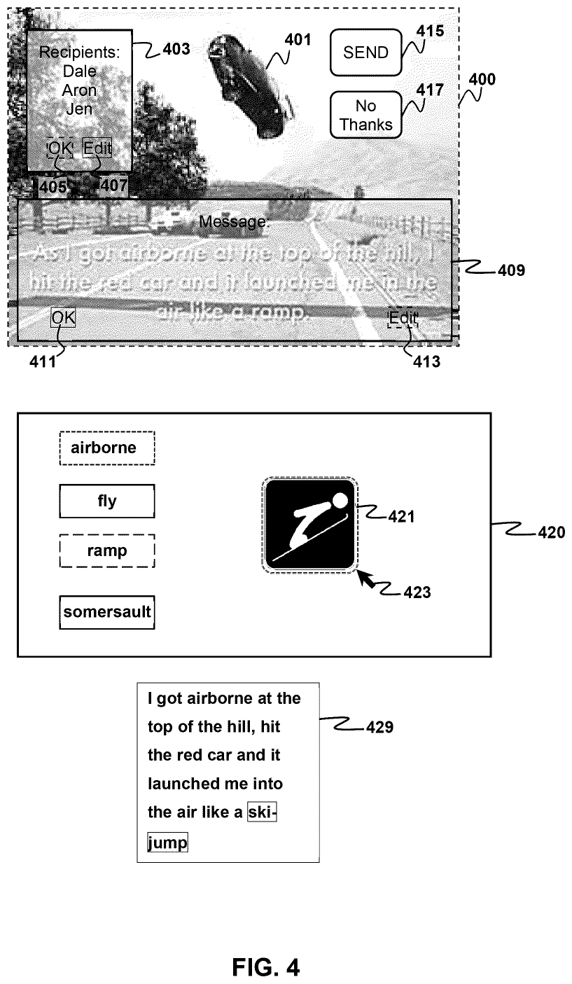

FIG. 4 depicts an example of a screen shot of a game screen 400 showing automated generation of a message for sharing a video game highlight according to aspects of the present disclosure. This example illustrates a racing game in which the highlight detection module 110 has detected a highlight in which player's race car 401 is airborne following a collision with another car. The recording module 120 has recorded the highlight, e.g., as a screenshot or video snippet. The recipient selection module 130 has presented a list 403 of recipients on the game screen 400 along with an “OK” active element 405 that the player may select to accept the list and an “Edit” active element 407 that the user may select to edit the list. In the illustrated example, the player has accepted the list as indicated by the dashed lines around the “OK” active element 405. The message drafting module 140 has presented a draft message 409 on the game screen 400 along with an “OK” active element 411 that the player may select to accept the message as drafted and an “Edit” active element 413 that the user may select to edit the message. In the illustrated example, the player has selected the “Edit” active element 413.

In the illustrated example, a user interface has also presented a “SEND” active element 415 the player may select to send the message as drafted by the message drafting module 140 to the recipients determined by the recipient selection module 130. In the illustrated example, the user interface has also presented a “NO THANKS” active element, which the user may select to discard the message without sending it.

There are a number of ways the system 100 may be operable to send the message with the highlight. For example, the system 100 may interface with an instant messaging system or email system in response to the player selecting the “SEND” active element 415. The instant message or email system may then package the highlight with drafted message, e.g., as an attachment or incorporated into the message and send it to the determined recipients. Alternatively, the system 100 may interface with a social media platform or video sharing platform. When the player selects the “SEND” active element, the system uploads the message and highlight to the social media platform or video sharing platform and notifies the recipients. In some implementations, the system 100 may include the drafted message in a notification sent to the recipients.

By way of example, the message generation module 140 may present the user with a standard editing screen that allows the player to make edits by typing them into the drafted message. In some implementations, the message drafting module may present a simplified editing screen 420 that allows the player to select words or icons that the drafting module may use to rewrite the message 409. In some implementations, the editing screen may show particular words or icons the message drafting module has used to draft the message. The user may de-select these words or icons in favor of others that are listed or may enter others, e.g., from a drop-down list or by typing them in to a text entry box. In the illustrated example, the word “airborne” was used to draft the message 409 as was the word “ramp”. The player has de-selected the word “ramp” as indicated by the long dashed outline of the word. In its place, the player has selected an icon 421 representing a ski jump using a cursor 423.

There are a number of reasons highlight detection module 110 may have selected the screen shot depicted in the upper portion of FIG. 4 or a corresponding video snippet. For example, the player may have previously posted screenshots or video snippets of his or her own similar crashes or may have expressed excitement during such crashes in other game sessions, e.g., with the same game or a different game, or the current game session. Alternatively, the highlight detection module 110 may have determined that, e.g., the height and/or duration of the flight of the race car 401 is particularly noteworthy compared to other such crashes for the same player or for other players. The highlight generation module 110 may analyze the game video and/or corresponding game engine data to generate information that summarizes what is shown in the screen shot or video snippet. In some implementations, the highlight generation module may utilize a system architecture like that shown in FIG. 3 and described above to generate the context information. By way of example and not by way of limitation, the context information may include the game title, game world location, e.g., racetrack, and context information about the highlight. Such context information may be useful in selecting the recipients or drafting the message 409. In the illustrated instance, the context information may indicate, among other things, that the highlight involves a crash in which a car is flies in the air and performs a somersault after colliding with another car. Portions of this context information may be sent to the recipient selection module 130 and message generation module 140.

There are a number of reasons recipient selection module 130 may have selected the recipients in the list 403 to receive the corresponding video snippet. For example, the player may have previously shared screenshots or video snippets of his or her own similar crashes with these players on social media or may have expressed excitement during such crashes in game chat with these players during game sessions with the same game or a different game, or during the current game session. Alternatively, the highlight detection module 110 may have determined that, those on the list 403 are (a) somehow associated with the player, e.g., via social media or by frequently playing games together and (b) interested in videos of crashes in video games.

The message generation module 140 may take a number of factors into account in generating the message 409. For example, the message generation module 140 may have determined that the player likes to describe the crash and use a particular style or tone in the description. The highlight generation module 110 may provide the message generation module a list of words derived from context information that describes the crash, e.g., “airborne at hill, hit red car, and launch”. The message generation module may use a text-generating AI chatbot, such as ChatGPT to generate the message from these words.

### Neural Networks

As noted above, the highlight detection module 110 and/or recipient selection module 130 and/or message drafting module 140 may include neural networks. A neural network is to a type of machine learning model that includes interconnected nodes or “neurons” that process and transmit information. Neural networks can learn and recognize patterns in data, making them useful for a wide range of applications, such as image recognition, natural language processing, and predictive modeling. In a neural network, data is input to a first layer of nodes, which processes the data and passes it on to the next layer. This process is repeated through several layers, with each layer transforming the data until the final layer produces an output, sometimes referred to as a label. The connections between nodes in a neural network are represented by weights, which are adjusted during a training process to improve the network's ability to accurately predict outputs given inputs.

As generally understood by those skilled in the art, training a neural network is a process of teaching a computer program to make accurate predictions or decisions based on data. The network consists of multiple layers of interconnected nodes, which are like simple computational units. During the training process, the network is presented with a set of input data, and the output it generates is compared with the expected output. The difference between the actual output and the expected output is measured using a cost function. The network then adjusts its parameters to minimize this cost function, so that the output it produces becomes closer to the desired output. This adjustment is done by a process called backpropagation, which involves computing the gradient of the cost function with respect to each parameter in the network. The gradient tells us how much each parameter should be adjusted to reduce the cost function. This process is repeated for many iterations, with the network being presented with different examples from the training data each time. Over time, the network learns to make better predictions or decisions based on the patterns in the data, and it becomes more accurate at tasks like recognizing images or translating languages.

According to aspects of the present disclosure, the neural networks may be pre-trained with masked data and fine-tuned with labeled data. Pre-training with masked data involves feeding the network input data with some of the inputs randomly masked or hidden and then training the network to predict the masked inputs. This approach can be useful when the available labeled data is limited, as it can help the network learn more general features from the data.

Labeled data includes input data and corresponding output data (or labels) that the network needs to predict. The pre-trained network may be initialized with random weights and then trained on the labeled data, with the goal of minimizing the difference between the network's predictions and the correct labels. This process may be repeated for multiple epochs (passes over the training data) until the network's performance on a separate validation dataset stops improving.

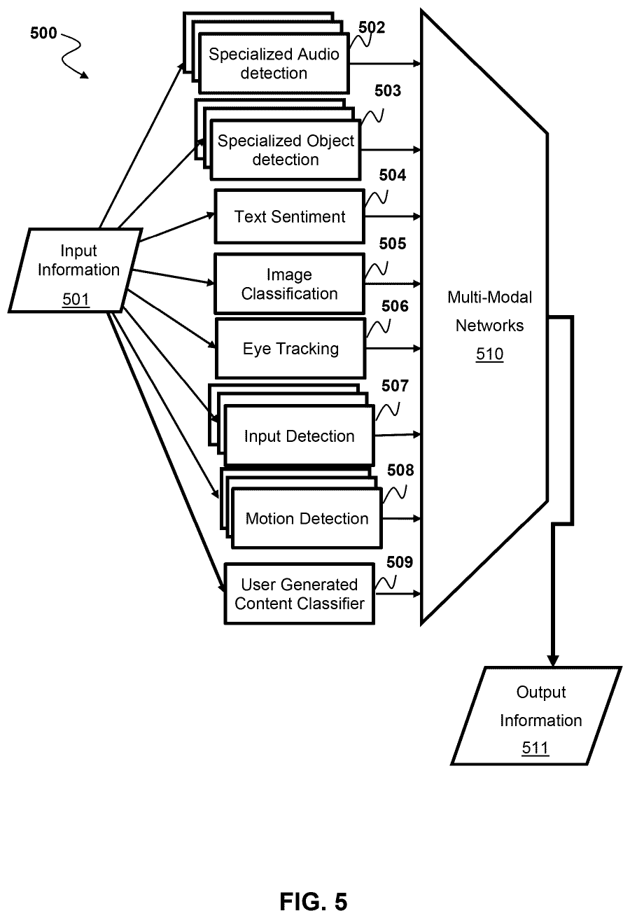

According to aspects of the present disclosure one or more of the highlight detection module 110, recipient selection module 130 and message drafting module 140 may analyze multi-modal input. FIG. 5 is a diagram depicting an example layout of unimodal modules in a multi-modal recognition network of the inference engine according to aspects of the present disclosure. As shown the inference engine includes one or more unimodal modules operating on different modalities of input information 501 and a multi-modal module which receives information from the unimodal modules. In the implementation shown the inference engine 500 includes the unimodal modules of; one or more audio detection modules 502, one or more object detection modules 503, a text sentiment module 504, an image classification module 505, eye tracking module 506, one or more input detection modules 507, one or more motion detection modules 508, and a user generated content classifier 509. The inference engine also includes a multimodal neural network module which takes the outputs of the unimodal modules and generates highlight information 511 in the UDS format.

### Audio Detection Modules

The one or more audio detection modules 502 may include one or more neural networks trained to classify audio data. Additionally, the one or more audio detection modules may include audio pre-processing stages and feature extraction stages. The audio preprocessing stage may be operable to condition the audio for classification by one or more neural networks.

Pre-processing may be optional because audio data is received directly from the input information 501 and therefore would not need to be sampled and would ideally be free from noise. Nevertheless, the audio may be preprocessed to normalize signal amplitude and adjust for noise.

The feature extraction stage may generate audio features from the audio data to capture feature information from the audio. The feature extraction stage may apply transform filters to the pre-processed audio based on human auditory features such as for example and without limitation Mel Frequency cepstral coefficients (MFCCs) or based Spectral Feature of the audio for example short time Fourier transform. MFCC may provide a good filter selection for speech because human hearing is generally tuned for speech recognition additionally because most applications are designed for human use the audio may be configured for the human auditory system. Short Fourier Transform may provide more information about sounds outside the human auditory range and may be able to capture features of the audio lost with MFCC.

The extracted features are then passed to one or more of the audio classifiers. The one or more audio classifiers may be neural networks trained with a machine learning algorithm to classify events from the extracted features. The events may be game events such as gun shots, player death sounds, enemy death sounds, menu sounds, player movement sounds, enemy movement sounds, pause screen sounds, vehicle sounds, or voice sounds. In some implementations the audio detection module may speech recognition to convert speech into a machine-readable form and classify key words or sentences from the text. In some alternative implementations text generated by speech recognition may be passed to the text and character extraction module for further processing. According to some aspects of the present disclosure the classifier neural networks may be specialized to detect a single type of event from the audio. For example and without limitation, there may be a classifier neural network trained to only classify features corresponding to weapon shot sounds and there may be another classifier neural network to recognize vehicle sounds. As such for each event type there may be a different specialized classifier neural network trained to classify the event from feature data. Alternatively, a single general classifier neural network may be trained to classify every event from feature data. Or in yet other alternative implementations a combination of specialized classifier neural network and generalized classifier neural networks may be used. In some implementations the classifier neural networks may be application specific and trained off a data set that includes labeled audio samples from the application. In other implementations the classifier neural network may be a universal audio classifier trained to recognize events from a data set that includes labeled common audio samples. Many applications have common audio samples that are shared or slightly manipulated and therefore may be detected by a universal audio classifier. In yet other implementations a combination of universal and application specific audio classifier neural networks may be used. In either case the audio classification neural networks may be trained de novo or alternatively may be further trained from pre-trained models using transfer learning. Pre-trained models for transfer learning may include without limitation VGGish, Sound net, Resnet, Mobilenet. Note that for some pre-trained models, such as Resnet and Mobilenet the audio would be converted to spectrograms before classification.

In training the audio classifier neural networks, whether de novo or from a pre-trained module, the audio classifier neural networks may be provided with a dataset of game play audio. The dataset of gameplay audio used during training has known labels. The known labels of the data set are masked from the neural network at the time when the audio classifier neural network makes a prediction, and the labeled gameplay data set is used to train the audio classifier neural network with the machine learning algorithm after it has made a prediction as is discussed in the generalized neural network training section. In some implementations the universal neural network may also be trained with other datasets having known labels such as for example and without limitation real world sounds, movie sounds or You Tube video.

There are a number of different audio cues that the audio detection modules may be trained to detect and classify. For example and without limitation, audio cues such as crescendos, diminuendos and a series of staccato notes may indicate an exciting or interesting moment is occurring. Additionally in some implementations the audio detection module may be trained on responses from the user to recognize user specific responses in the recorded audio. The system may request user feedback to refine the classification of user responses. This sentiment classification may be passed as feature data to a multimodal neural network trained to identify highlights.

### Object Detection Modules

The one or more object detection modules 503 may include one or more neural networks trained to classify objects occurring within an image frame of video or an image frame of a still image. Additionally, the one or more object detection modules may include a frame extraction stage, an object localization stage, and an object tracking stage.

The frame extraction stage may simply take image frame data directly from the unstructured data. In some implementations the frame rate of video data may be down sampled to reduce the data load on the system. Additionally in some implementations the frame extraction stage may only extract key frames or I-frames if the video is compressed. In other implementations, only a subset of the available channels of the video may be analyzed. For example, it may be sufficient to analyze only the luminance (brightness) channel of the video but not the chrominance (color) channel. Access to the full unstructured data also allows frame extraction to discard or use certain rendering layers of video. For example and without limitation, the frame extraction stage may extract the UI layer without other video layers for detection of UI objects or may extract non UI rendering layers for object detection within a scene.

The object localization stage identifies features within the image. The object localization stage may use algorithms such as edge detection or regional proposal. Alternatively, the neural network may include deep learning layers that are trained to identify features within the image may be utilized.

The one or more object classification neural networks are trained to localize and classify objects from the identified features. The one or more classification neural networks may be part of a larger deep learning collection of networks within the object detection module. The classification neural networks may also include non-neural network components that perform traditional computer vision tasks such as template matching based on the features. The objects that the one or more classification neural networks are trained to localize and classify includes for example and without limitation, Game icons such as; player map indicator, map location indictor (Points of interest); item icons, status indicators, menu indicators, save indicators, and character buff indicators, UI elements such as health level, mana level, stamina level, rage level, quick inventory slot indicators, damage location indicators, UI compass indicators, lap time indicators, vehicle speed indicators, and hot bar command indicators, application elements such as weapons, shields, armors, enemies, vehicles, animals, trees, and other interactable elements.

According to some aspects of the present disclosure the one or more object classifier neural networks may be specialized to detect a single type of object from the features. For example and without limitation, there may be object classifier neural network trained to only classify features corresponding to weapons and there may be another classifier neural network to recognize vehicles. As such for each object type there may be a different specialized classifier neural network trained to classify the object from feature data. Alternatively, a single general classifier neural network may be trained to classify every object from feature data. Or in yet other alternative implementations a combination of specialized classifier neural network and generalized classifier neural networks may be used. In some implementations the object classifier neural networks may be application specific and trained off a data set that includes label audio samples from the application. In other implementations the classifier neural network may be a universal object classifier trained to recognize objects from a data set that includes labeled frames containing common objects. Many applications have common objects that are shared or slightly manipulated and therefore may be detected by a universal object classifier. In yet other implementations a combination of universal and application specific object classifier neural networks may be used. In either case the object classification neural networks may be trained de novo or alternatively may be further trained from pre-trained models using transfer learning. Pre-trained models for transfer learning may include without limitation Faster R-CNN (Region-based convolutional neural network), YOLO (You only look once), SSD (Single shot detector), and Retinanet.

Frames from the application may be still images or may be part of a continuous video stream. If the frames are part of a continuous video stream the object tracking stage may be applied to subsequent frames to maintain consistency of the classification over time. The object tracking stage may apply known object tracking algorithms to associate a classified object in a first frame with an object in a second frame based on for example and without limitation the spatial temporal relation of the object in the second frame to the first and pixel values of the object in the first and second frame.

In training the object detection neural networks, whether de novo or from a pre-trained model, the object detection classifier neural networks may be provided with a dataset of game play video. The dataset of gameplay video used during training has known labels. The known labels of the data set are masked from the neural network at the time when the object classifier neural network makes a prediction, and the labeled gameplay data set is used to train the object classifier neural network with the machine learning algorithm after it has made a prediction as is discussed in the generalized neural network training section. In some implementations the universal neural network may also be trained with other datasets having known labels such as for example and without limitation real world images of objects, movies or YouTube video.

### Text Sentiment

Text and character extraction are similar tasks to object recognition. The text sentiment module 504 may include a video preprocessing component, text detection component and text recognition component.

Where video frames contain text, the video preprocessing component may modify the frames or portions of frames to improve recognition of text. For example and without limitation, the frames may be modified by preprocessing de-blurring, de-noising, and contrast enhancement. In some situations, video preprocessing may not be necessary, e.g., if the user enters text into the system in machine readable form.

Text detection components may be applied to frames and operable to identify regions that contain text if user entered text is not in a machine-readable form. Computer vision techniques such as edge detection and connected component analysis may be used by the text detection components. Alternatively, text detection may be performed by a deep learning neural network trained to identify regions containing text.

Low level Text recognition may be performed by optical character recognition. The recognized characters may be assembled into words and sentences. Higher level text recognition may then analyze assembled words and sentences to determine sentiment. In some implementations, a dictionary may be used to look up and tag words and sentences that indicate sentiment or interest. Alternatively, a neural network may be trained with a machine learning algorithm to classify Sentiment and/or interest. For example and without limitation, the text recognition neural networks may be trained to recognize words and/or phrases that indicate interest, excitement, concentration etc. Similar to above, the text recognition neural network or dictionary may be universal and shared between applications or specialized for each application or a combination of the two. Furthermore, in some implementations, the text recognition neural network may be trained with user input text, such as in-game text chat or user text feedback.

In training the high-level text recognition neural networks may be trained de novo or using transfer learning from a pre-trained neural network. Pre-trained neural networks that may be used with transfer learning include for example and without limitation Generative Pre-trained Transformer (GPT) 2, GPT 3, GPT 4, Universal Language Model Fine-Tuning (ULMFIT), Embeddings from Language Models (ELMo), Bidirectional Encoder Representations from Transformers (BERT) and similar. Whether de novo or from a pre-trained model, the high-level Text recognition neural networks may be provided with a dataset of user entered text. The dataset of user entered text used during training has known labels for sentiment. The known labels of the data set are masked from the neural network at the time when the high level text recognition neural network makes a prediction, and the labeled user entered text data set is used to train the high level text recognition neural network with the machine learning algorithm after it has made a prediction as is discussed in the generalized neural network training section. In some implementations the universal neural network may also be trained with other datasets having known labels such as for example and without limitation real world text, books, or websites.

### Image Classification

The Image classification module 505 classifies the entire image of the screen whereas object detection decomposes elements occurring within the image frame. The task of image classification is similar to object detection except it occurs over the entire image frame without an object localization stage and with a different training set. An image classification neural network may be trained to classify interest from an entire image. Interesting images may be images that are frequently captured as screenshots or in videos by users or frequently re-watched on social media and may be for example victory screens, game over screens, death screens, frames of game replays etc.

The image classification neural networks may be trained de novo or trained using transfer learning from a pre-trained neural network. Whether de novo or from a pre-trained module, the image classification neural networks may be provided with a dataset of gameplay image frames. The dataset of gameplay image frames used during training has known labels of interest. The known labels of the data set are masked from the neural network at the time when the image classification neural network makes a prediction, and the labeled gameplay data set is used to train the image classification neural network with the machine learning algorithm after it has made a prediction as is discussed in the generalized neural network training section. In some implementations the universal neural network may also be trained with other datasets having known labels such as for example and without limitation images of the real world, videos of gameplay or game replays. Some examples of pre-trained image recognition models that can be used for transfer learning include, but are not limited to, VGG, ResNet, EfficientNet, DenseNet, MobileNet, VIT, GoogLeNet, Inception, and the like.

The image classification neural networks may be trained de novo or trained using transfer learning from a pre-trained neural network. Whether de novo or from a pre-trained module, the image classification neural networks may be provided with a dataset of gameplay image frames. The dataset of gameplay image frames used during training has known labels. The known labels of the data set are masked from the neural network at the time when the image classification neural network makes a prediction, and the labeled gameplay data set is used to train the image classification neural network with the machine learning algorithm after it has made a prediction as is discussed in the generalized neural network training section. In some implementations the universal neural network may also be trained with other datasets having known labels such as for example and without limitation images of the real world, videos of gameplay or game replays.

### Eye Tracking

A player's gaze can provide an important clue to their level of interest. Eye tracking information may therefore be useful to the highlight detection module 140 for detecting highlights. Eye tracking information may also be useful to the recipient selection module 130 for determining recipients of highlights. Eye tracking information may additionally be useful to the messaging module 140, e.g., to determine a sentiment or tone for a message.

The eye tracking module 506 may take gaze tracking data from a HUD and correlate the eye tracking data to areas of the screen and interest. During eye tracking an infrared emitter illuminates the user's eyes with infrared light causing bright reflections in the pupil of the user. These reflections are captured by one or more cameras focused on the eyes of the user in the HUD. The eye tracking system may go through a calibration process to correlate reflection with eye positions. The eye tracking module may detect indicators of interest such as fixation and correlate those indicators of interest to particular areas of the screen and frames in the application.

Detecting fixation and other indicators of interest may include calculating mean and variance of gaze position along with timing. Alternatively complex machine learning methods such as principal component analysis or independent component analysis may be used. These extraction methods may discover underlying behavioral elements in the eye movements.

Additional deep learning machine learning models may be used to associate the underlying behavior elements of the eye movements to events occurring in the frames to discover indicators of interest from eye tracking data. For example and without limitation, eye tracking data may indicate that the user's eyes fixate for a particular time period during interesting scenes as determined from viewer hotspots or screenshot/replay generation by the user. This information may be used during training to associate that particular fixation period as a feature for highlight training.

Machine learning models may be trained de novo or trained using transfer learning from a pre-trained neural networks. Pre-trained neural networks that may be used with transfer learning include for example and without limitation Pupil labs and PyGaze.

### Input Detection

The input information 501 may include inputs from peripheral devices. The input detection module 507 may take the inputs from the peripheral devices and identify the inputs that correspond to interest or excitement from the user. In some implementations the input detection module 507 may include a table containing inputs timing thresholds that correspond to interest from the user. For example and without limitation, the table may provide an input threshold of 100 milliseconds between inputs representing interest/excitement from the user; these thresholds may be set per application. Additionally, the table may exclude input combination or timings used by the current application thus tracking only extraneous input combinations and/or timings by the user that may indicate user sentiments. Alternatively, the input detection module may include one or more input classification neural networks trained to recognize interest/excitement of the user. Different applications may require different input timings and therefore each application may require a customized model. Alternatively, according to some aspects of the present disclosure one or more of the input detection neural networks may be universal and shared between applications. In yet other implementations a combination of universal and specialized neural networks is used. Additionally in alternative implementations the input classification neural networks may be highly specific with a different trained neural network to identify one specific indicator of interest/excited for the structured data.

The input classification neural networks may be provided with a dataset including peripheral inputs occurring during use of the computer system. The dataset of peripheral inputs used during training have known labels for excitement/interest of the user. The known labels of the data set are masked from the neural network at the time when the input classification neural network makes a prediction, and the labeled data set of peripheral inputs is used to train the input classification neural network with the machine learning algorithm after it has made a prediction as is discussed in the generalized neural network training section. A specialized input classification neural network may have a data set that consists of recordings of inputs sequences that occur during operation of a specific application and no other applications; this may create a neural network that is good at predicting actions for a single application. In some implementations, a universal input classification neural network may also be trained with other datasets having known labels such as for example and without limitation excited/interested input sequences across many different applications.

### Motion Detection

Many applications also include a motion component in the input information 501 that may provide commands which could be included in context information. The motion detection module 508 may take the motion information from the input information 501 and turn the motion data into commands for the context information. A simple approach to motion detection may include simply providing different thresholds and outputting a command each time an element from an inertial measurement unit exceeds the threshold. For example and without limitation, the system may include a 2 gravity acceleration threshold in the X axis to output a command that the headset is changing direction. Additionally, the thresholds may exclude known movements associated with application commands allowing the system to track extraneous movements that indicate user sentiment.

Another alternative approach is neural network based motion classification. In this implementation the motion detection module 508 may include components for motion preprocessing, feature selection and motion classification. The motion preprocessing component conditions the motion data to remove artifacts and noise from the data. The preprocessing may include noise floor normalization, mean selection, standard deviation evaluation, Root mean square torque measurement, and spectral entropy signal differentiation. The feature selection component takes preprocessed data and analyzes the data for features. Selecting features using techniques for example and without limitation principal component analysis, correlational analysis, sequential forward selection, backwards elimination and mutual information.

Finally, the selected features are applied to the motion classification neural networks trained with a machine learning algorithm to classify commands from motion information. In some implementations the selected features are applied to other machine learning models which do not include a neural network for example and without limitation, decision trees, random forests, and support vector machines. Some inputs are shared between applications for example and without limitation, many applications selection commands are simple commands to move a cursor. Thus, according to some aspects of the present disclosure one or more of the motion classification neural networks may be universal and shared between applications. In some implementations the one or more motion classification neural networks may be specialized for each application and trained on a data set consisting of commands for the specific chosen application. In yet other implementation a combination of universal and specialized neural networks are used. Additionally in alternative implementations the motion classification neural networks may be highly specific with a different trained neural network to identify each command for the context data.

The motion classification neural networks may be provided with a dataset including motion inputs occurring during use of the computer system. The dataset of motion inputs used during training has known labels for commands. The known labels of the data set are masked from the neural network at the time when the motion classification neural network makes a prediction, and the labeled data set of motion inputs is used to train the motion classification neural network with the machine learning algorithm after it has made a prediction as is discussed in the generalized neural network training section. A specialized motion classification neural network may have a data set that consists of recordings of inputs sequences that occur during operation of a specific application and no other application; this may create a neural network that is good at predicting actions for a single application. In some implementations a universal motion classification neural network may also be trained with other datasets having known labels such as for example and without limitation input sequences across many different applications.

### User Generated Content Classification

The system may also be operable to classify sentiments occurring within user generated content. As used herein user generated content may be data generated by the user on the system coincident with use of the application. For example and without limitation, user generated content may include chat content, blog posts, social media posts, screen shots, user generated documents. The User Generated Content Classification module 509 may include components from other modules such as the text sentiment module and the object detection module to place the user generated content in a form that may be used as context data. For example and without limitation, the User Generated Content Classification may decompose text and character extraction components to identify contextually important statements made by the user in a chat room. As a specific, non-limiting example the user may make a statement in chat such as ‘I'm so excited’ or ‘check this out’ which may be detected and used to indicate sentiment for a time point in the application.

### Multi-Modal Networks

The multimodal highlight detection neural networks 510 fuse the information generated by the modules 502-509 and generate a time stamped prediction which is used to retrieve image data from the structured data to create output information 511 from the separate modal networks of the modules. In some implementations the data from the separate modules are concatenated together to form a single multi-modal vector. The multi-modal vector may also include the data from structured data.

By way of example, the output of a multimodal neural network 510 that is part of the highlight detection module 110 may include a classification associated with a timestamp of when the highlight occurred in the application data. The classification may simply confirm that a highlight occurred or may provide a sentiment associated with the highlight. A buffer of image frames correlated by stamp may be kept by the device or on a remote system. The highlight detection engine may use the timestamp associated with the classification to retrieve the image frame to create the highlight as output information 511 from the buffer. In some implementations the output of the multimodal highlight detection neural network includes a series or range of time stamps, and the highlight detection engine may request the series of timestamps or range of time stamps from the buffer to generate a video highlight. In some alternative implementations the highlight detection engine may include a buffer which receives image frame data and organizes the image frames by timestamp.

The multi-modal neural networks 510 may be trained with a machine learning algorithm to take the multi-modal vector and predict output data 511, e.g., a highlight for the highlight detection module 110, a compatibility score for the recipient selection module 130 or one or more keywords for the message generation module 140. Training the multi-modal neural networks 510 may include end to end training of all of the modules with a data set that includes labels for multiple modalities of the input data. During training, the labels of the multiple input modalities are masked from the multi-modal neural networks before prediction. The labeled data set of multi-modal inputs is used to train the multi-modal neural networks with the machine learning algorithm after it has made a prediction as is discussed below in the generalized neural network training section.

### Multi-Modal Networks

The multi-modal networks 510 fuse the information generated by the modules 502-509 and generates relevant output information 511 from the separate modal networks of the modules. In some implementations the data from the separate modules are concatenated together to form a single multi-modal vector. The multi-modal vector may also include unprocessed data from unstructured data. The nature of the output information depends on the nature of the module that produces it. For example, the highlight detection module 110 may produce an output corresponding to a highlight. Similarly, the recipient selection module 130 may produce an output corresponding to one or more determined recipients of a detected highlight and the message generation module 140 may produce output corresponding to a message associated with a detected highlight.

The multi-modal neural networks 510 may be trained with a machine learning algorithm to take the multi-modal vector and generate relevant output information 511. Training the multi-modal neural networks 510 may include end to end training of all of the modules with a data set that includes labels for multiple modalities of the input data. During training the labels of the multiple input modalities are masked from the multi-modal neural networks before prediction. The labeled data set of multi-modal inputs is used to train the multi-modal neural networks with the machine learning algorithm after it has made a prediction as is discussed in the generalized neural network training section below.

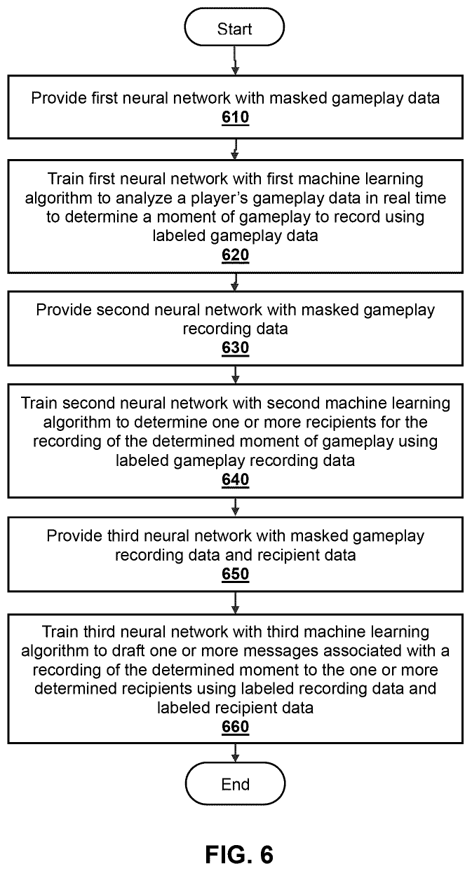

As discussed above, the highlight detection module 110, recipient selection module 130 and message drafting module 140 may include trained neural networks. Aspects of the present disclosure include methods of training such neural networks. By way of example, and not by way of limitation, FIG. 6 depicts a flowchart that illustrates a method for training feedback message generation system for video games, according to some aspects of the present disclosure. In some implementations, at 610, the method may include providing masked gameplay data for a video game to a first neural network, such as neural network 112 in the highlight detection module 110. In some implementations, the masked gameplay data may include one or more modes of multimodal gameplay data. In some implementations, the masked gameplay data may be provided in the form of one or more feature vectors to reduce the dimensionality of the data while retaining the relevant information. As indicated at 620, the first neural network may be trained with a first machine learning, e.g., algorithm 114, to analyze a player's gameplay data in real time to determine a moment of gameplay to record using labeled gameplay data, which may include one or more modes of multimodal data or may include one or more feature vectors. At 630, the method may include providing a second neural network, such as neural network 132 of the recipient selection module 130 with masked gameplay recording data for a video game. In some implementations, the masked gameplay recording data may be provided in the form of one or more feature vectors to reduce the dimensionality of the data while retaining the relevant information. The second neural network is then trained with a second machine learning algorithm, e.g., algorithm 134, to determine one or more recipients for the recording of the determined moment of gameplay using labeled gameplay recording data, as indicated at 640. Then, at 650 a third neural network, e.g., neural network 142, is provided with masked gameplay recording data and recipient data. The third neural network is then trained with a third machine learning algorithm, e.g., algorithm 144 to draft one or more messages associated with the recording of the determined moment to the one or more determined recipients using labeled recording data and labeled recipient data, as indicated at 660.

Although the aspects of the disclosure are not so limited, many of the implementations discussed above utilize trained neural networks trained by corresponding machine learning algorithms. Aspects of the present disclosure include methods of training such neural networks with such machine learning algorithms. By way of example, and not limitation, there are a number of ways that the machine learning algorithms 114, 134, and 144 may train the corresponding neural networks 112, 132, and 142. Some of these are discussed in the following section.

### Generalized Neural Network Training

The NNs discussed above may include one or more of several different types of neural networks and may have many different layers. By way of example and not by way of limitation the neural network may consist of one or multiple convolutional neural networks (CNN), recurrent neural networks (RNN) and/or dynamic neural networks (DNN). The Motion Decision Neural Network may be trained using the general training method disclosed herein.

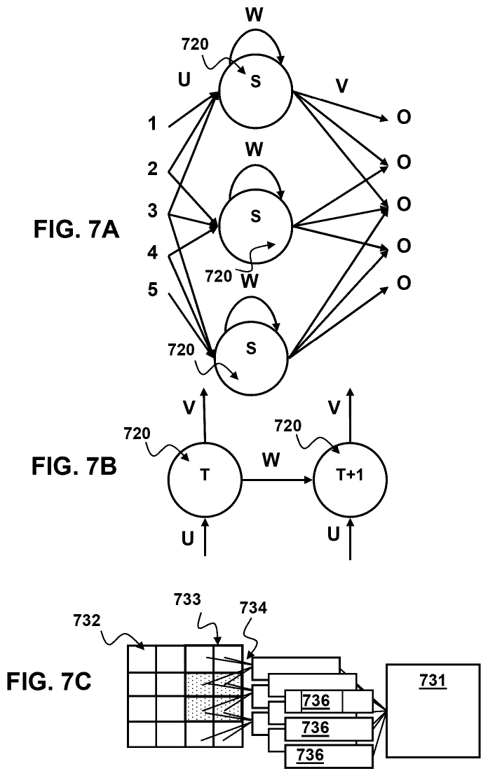

By way of example, and not limitation, FIG. 7A depicts the basic form of an RNN that may be used, e.g., in the trained model. In the illustrated example, the RNN has a layer of nodes 720, each of which is characterized by an activation function S, one input weight U, a recurrent hidden node transition weight W, and an output transition weight V. The activation function S may be any non-linear function known in the art and is not limited to the (hyperbolic tangent (tanh) function. For example, the activation function S may be a Sigmoid or ReLu function. Unlike other types of neural networks, RNNs have one set of activation functions and weights for the entire layer. As shown in FIG. 7B, the RNN may be considered as a series of nodes 720 having the same activation function moving through time T and T+1. Thus, the RNN maintains historical information by feeding the result from a previous time T to a current time T+1.

In some implementations, a convolutional RNN may be used. Another type of RNN that may be used is a Long Short-Term Memory (LSTM) Neural Network which adds a memory block in a RNN node with input gate activation function, output gate activation function and forget gate activation function resulting in a gating memory that allows the network to retain some information for a longer period of time as described by Hochreiter & Schmidhuber “Long Short-term memory” Neural Computation 9(8):1735-1780 (1997), which is incorporated herein by reference.

FIG. 7C depicts an example layout of a convolution neural network such as a CRNN, which may be used, e.g., in a trained model according to aspects of the present disclosure. In this depiction, the convolution neural network is generated for an input 732 with a size of 4 units in height and 4 units in width giving a total area of 16 units. The depicted convolutional neural network has a filter 733 size of 2 units in height and 2 units in width with a skip value of 1 and a channel 736 of size 9. For clarity in FIG. 7C only the connections 734 between the first column of channels and their filter windows is depicted. Aspects of the present disclosure, however, are not limited to such implementations. According to aspects of the present disclosure, the convolutional neural network may have any number of additional neural network node layers 731 and may include such layer types as additional convolutional layers, fully connected layers, pooling layers, max pooling layers, local contrast normalization layers, etc. of any size.

As seen in FIG. 7D Training a neural network (NN) begins with initialization of the weights of the NN, as indicated at 741. In general, the initial weights should be distributed randomly. For example, a NN with a tanh activation function should have random values distributed between

$$- \frac{1}{\sqrt{n}}$$

and

$$\frac{1}{\sqrt{n}}$$

where n is the number of inputs to the node.

After initialization, the activation function and optimizer are defined. The NN is then provided with a feature vector or input dataset at 742. Each of the different feature vectors that are generated with a unimodal NN may be provided with inputs that have known labels. Similarly, the multimodal NN may be provided with feature vectors that correspond to inputs having known labeling or classification. The NN then predicts a label or classification for the feature or input at 743. The predicted label or class is compared to the known label or class (also known as ground truth) and a loss function measures the total error between the predictions and ground truth over all the training samples at 744. By way of example and not by way of limitation the loss function may be a cross entropy loss function, quadratic cost, triplet contrastive function, exponential cost, etc. Multiple different loss functions may be used depending on the purpose. By way of example and not by way of limitation, for training classifiers a cross entropy loss function may be used whereas for learning pre-trained embedding a triplet contrastive function may be employed. The NN is then optimized and trained, using the result of the loss function and using known methods of training for neural networks such as backpropagation with adaptive gradient descent etc., as indicated at 745. In each training epoch, the optimizer tries to choose the model parameters (i.e., weights) that minimize the training loss function (i.e., total error). Data is partitioned into training, validation, and test samples.

During training, the Optimizer minimizes the loss function on the training samples. After each training epoch, the model is evaluated on the validation sample by computing the validation loss and accuracy. If there is no significant change, training can be stopped, and the resulting trained model may be used to predict the labels of the test data.

Thus, the neural network may be trained from inputs having known labels or classifications to identify and classify those inputs. Similarly, a NN may be trained using the described method to generate a feature vector from inputs having a known label or classification. While the above discussion is relation to RNNs and CRNNS the discussions may be applied to NNS that do not include Recurrent or hidden layers.

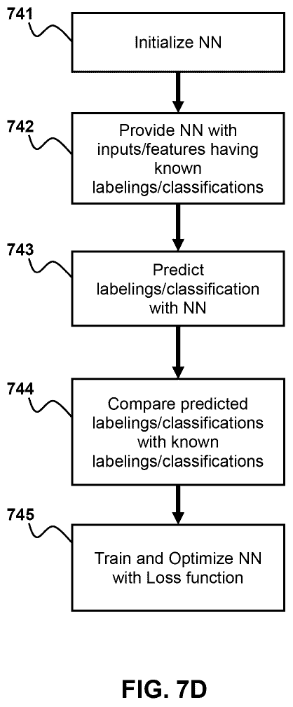

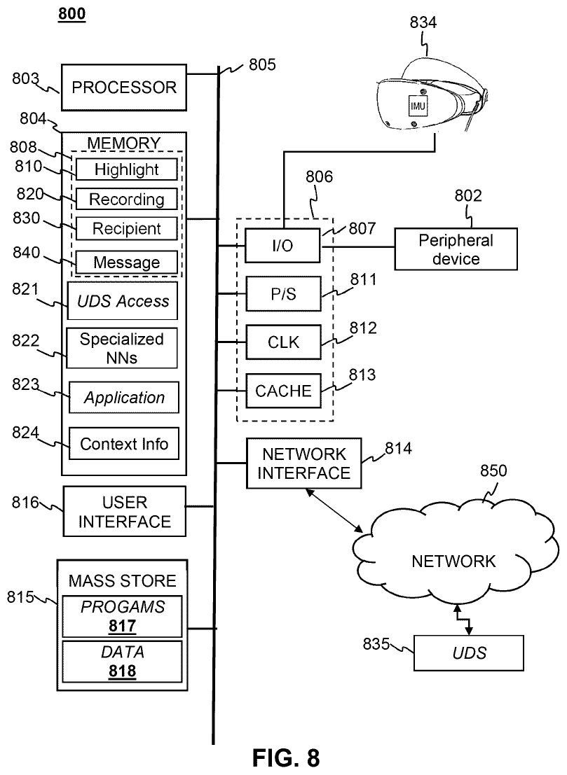

FIG. 8 depicts a system according to aspects of the present disclosure. The system may include a computing device 800 coupled to a user peripheral device 802 and a HUD 834. The peripheral device 802 may be a controller, display, touch screen, microphone or other device that allows the user to input speech data in to the system. The HUD 834 may be a Virtual Reality (VR) headset, Altered Reality (AR) headset or similar. The HUD may include one or more IMUs which may provide motion information to the system. Additionally, the peripheral device 802 may also include one or more IMUs.

The computing device 800 may include one or more processor units and/or one or more graphical processing units (GPU) 803, which may be operable according to well-known architectures, such as, e.g., single-core, dual-core, quad-core, multi-core, processor-coprocessor, cell processor, and the like. The computing device may also include one or more memory units 804 (e.g., random access memory (RAM), dynamic random-access memory (DRAM), read-only memory (ROM), and the like). The computing device may optionally include a mass storage device 815 such as a disk drive, CD-ROM drive, tape drive, flash memory, or the like, and the mass storage device may store programs and/or data.

The processor unit 803 may execute one or more programs, portions of which may be stored in memory 804 and the processor 803 may be operatively coupled to the memory, e.g., by accessing the memory via a data bus 805. The programs may be operable to implement a frictionless AI-assisted video game messaging system 808, which may include a highlight detection module 810, recording module 820, recipient selection module 830 and message generation module 840. These modules may be operable, e.g., as discussed above. The memory 804 may also contain software modules such as a UDS system access module 821 and specialized NN Modules 822. By way of example, the specialized neural network modules may implement components of the inference engine 304. The Memory 804 may also include one or more applications 823, such as game applications, instant messaging applications, email applications, or social media interface applications. In addition, the memory 804 may store context information 824 generated by the messaging system 808 and/or the specialized neural network modules 822. The overall structure and probabilities of the NNs may also be stored as data 818 in the Mass Store 815 as well as some or all of the data available to the UDS 835. The processor unit 803 is further operable to execute one or more programs 817 stored in the mass store 815 or in memory 804 which cause the processor to carry out a method for training a NN from feature vectors and/or input data. The system may generate Neural Networks as part of the NN training process. These Neural Networks may be stored in the memory 804 as part of the location based feedback system 808, or Specialized NN Modules 821. Trained NNs and their respective machine learning algorithms may be stored in memory 804 or as data 818 in the mass store 815.

The computing device 800 may also include well-known support circuits, such as input/output (I/O) 807, circuits, power supplies (P/S) 811, a clock (CLK) 812, and cache 813, which may communicate with other components of the system, e.g., via the bus 805. The computing device may include a network interface 814 to facilitate communication with other devices. The processor 803 and network interface 814 may be operable to implement a local area network (LAN) or personal area network (PAN), via a suitable network protocol, e.g., Bluetooth, for a PAN. The computing device 800 may also include a user interface 816 to facilitate interaction between the system and a user. The user interface may include a keyboard, mouse, light pen, game control pad, touch interface, game controller, or other input device.

The network interface 814 to facilitate communication via an electronic communications network 850. For example, part of the UDS 835 may be implemented on a remove server that can be access via the network 850. The network interface 814 may be operable to facilitate wired or wireless communication over local area networks and wide area networks such as the Internet. The device 800 may send and receive data and/or requests for files via one or more message packets over the network 1620. Message packets sent over the network 850 may temporarily be stored in a buffer in the memory 804.

Aspects of the present disclosure may leverage artificial intelligence to provide video game players a frictionless way to share highlights of their gameplay with others. The ability to quickly share game experiences while they are still fresh may enhance player's gaming experience and improve player retention.

While the above is a complete description of several aspects of the present disclosure, it is possible to use various alternatives, modifications and equivalents. Any feature described herein, whether preferred or not, may be combined with any other feature described herein, whether preferred or not. In the claims that follow, the in definite article “A” or “An” refers to a quantity of one or more of the item following the article, except where expressly stated otherwise. The appended claims are not to be interpreted as including means-plus-function Imitations, unless such a limitation is explicitly recited in a given claim using the phrase “means for.”

What is claimed is:

1. A video game system, comprising:
a first trained neural network operable to analyze a player's gameplay data in real time to determine a moment of gameplay to record;
a recording module operable to record the moment of gameplay determined with the first trained neural network;
a second trained neural network operable to determine one or more recipients for the recording of the determined moment;
a third trained neural network operable to draft one or more messages associated with the determined moment to the one or more determined recipients; and
a user interface operable to present the player an opportunity send the recording of the determined moment and the one or more messages to the one or more recipients.

2. The system of claim 1, wherein the first neural network is trained to optimize the determined moment of gameplay for sharing with the one or more recipients.

3. The system of claim 1, wherein the first neural network is trained to optimize the determined moment of gameplay for maximum view counts for publicly shared gameplay video.

4. The system of claim 1, wherein the first neural network is trained to choose a virtual camera angle from which to record the determined moment of gameplay.

5. The system of claim 1, wherein the second trained neural network is trained to determine the one or more recipients from among a plurality of other players associated with the player.

6. The system of claim 1, wherein the third trained neural network is trained to draft the one or more messages with a tone based on the one or more recipients.

7. The system of claim 1, wherein the third trained neural network is trained to draft the one or more messages with a tone based on analysis of messages sent by the player.

8. The system of claim 1, wherein the third trained neural network is trained to draft the one or more messages with a tone based on a title of the video game.

9. The system of claim 1, wherein the third trained neural network is trained to draft the one or more messages with a tone based on the player's gameplay data.

10. The system of claim 1, wherein the third trained neural network is trained to draft the one or more messages from one or more inputs provided by the player.

11. The system of claim 1, wherein the third trained neural network is trained to suggest one or more inputs, such as words, icons, or emojis, for the player to select.

12. A video game method, comprising:
analyzing a player's gameplay data for a video game with a first trained neural network in real time to determine a moment of gameplay to record;
recording the moment of gameplay determined with the first trained neural network;
decomposing the recorded determined moment of gameplay to determine one or more recipients for the recording of the determined moment with a trained second neural network;
drafting one or more messages associated with the recorded determined moment to the one or more determined recipients with a third neural network; and
presenting the player an opportunity to send the recording of the determined moment and the one or more messages to the one or more recipients via a user interface.

13. A non-transitory computer-readable medium having executable instructions embodied therein, comprising:
a set of gameplay analysis instructions operable to analyze a player's gameplay data for a video game with a first trained neural network in real time to determine a moment of gameplay to record;
a set of recording instructions operable to record the determined moment of gameplay;
a set of decomposition instructions operable to decompose the recorded determined moment of gameplay to determine one or more recipients for the recording of the determined moment with a second trained neural network;
a set of drafting instructions operable to draft one or more messages associated with the recorded determined moment to the one or more determined recipients with a third trained neural network; and
a set of presentation instructions operable to present the player an opportunity send the recording of the determined moment and the one or more messages to the one or more recipients via a user interface.

14. A method for training a video game system, comprising:
providing a first neural network with masked gameplay data for a video game;
training the first neural network with a first machine learning algorithm to analyze a player's gameplay data in real time to determine a moment of gameplay to record using labeled gameplay data;
providing a second neural network with masked gameplay recording data;
training the second neural network with a second machine learning algorithm to determine one or more recipients for the recording of the determined moment of gameplay using labeled gameplay recording data;
providing a third neural network with masked gameplay recording data and recipient data; and
training the third neural network with a third machine learning algorithm to draft one or more messages associated with a recording of the determined moment to the one or more determined recipients using labeled recording data and labeled recipient data.

15. The method of claim 14, wherein the labeled gameplay data is selected to optimize the determined moment of gameplay for sharing with the one or more recipients.

16. The method of claim 14, wherein the labeled gameplay data is selected to optimize the determined moment of gameplay for maximum view counts for publicly shared gameplay video.

17. The method of claim 14, wherein the first machine learning algorithm is operable to train the first neural network to choose a virtual camera angle from which to record the determined moment of gameplay.

18. The method of claim 14, wherein the second machine learning algorithm trains the second neural network to determine the one or more recipients from among a plurality of other players associated with the player.

19. The method of claim 14, wherein the third machine learning algorithm trains the third neural network with messages to labeled recipients regarding labeled recordings.

20. The method of claim 14, wherein the third machine learning algorithm trains the third neural network to with a tone based on the one or more recipients.

21. The method of claim 14, wherein the third machine learning algorithm trains the third neural network to draft the one or more messages with a tone based on the recording of the determined moment.

22. The method of claim 14, wherein the third machine learning algorithm trains the third neural network to draft the one or more messages with a tone based on analysis of messages sent by the player.

23. The method of claim 14, wherein the third machine learning algorithm trains the third neural network to draft the one or more messages with a tone based on analysis of messages sent by the player to one or more of the one or more recipients.

24. The method of claim 14, wherein the third machine learning algorithm trains the third neural network to draft the one or more messages with a tone based on a title of the video game.

25. The method of claim 14, wherein the third machine learning algorithm trains the third neural network to draft the one or more messages with a tone based on the player's gameplay data.

26. The method of claim 14, wherein the third machine learning algorithm trains the third neural network to draft the one or more messages from one or more inputs provided by the player, such as words, icons or emojis.

27. The method of claim 14, wherein the third machine learning algorithm trains the third neural network to suggest one or more inputs, such as words, icons or emojis, for the player to select.
